(19) United States
(12) Patent Application Publication
(10) Pub. No.: US 2023/0146972 A1
(43) Pub. Date: May 11, 2023

(54) BATTERY MANAGEMENT METHOD AND POWER SUPPLY SYSTEM

(71) Applicant: Delta Electronics (Shanghai) Co.,Ltd., Shanghai (CN)

(72) Inventors: Weiguo SHEN, Shanghai (CN); Zucheng LIU, Shanghai (CN); Hui ZHOU, Shanghai (CN); Zhiqiang GAO, Shanghai (CN); Yinhui YANG, Shanghai (CN)

(21) Appl. No.: 18/051,522

(22) Filed: Nov. 1, 2022

(30) Foreign Application Priority Data
Nov. 10, 2021 (CN) 202111328611.5

(51) Int. Cl. H01M 10/44; H02J 7/00

(52) U.S. Cl. CPC H01M 10/441; H02J 7/007182; H02J 2207/10

(57) ABSTRACT

The application provides a battery management method and a power supply system. The battery management method includes: providing the power supply system comprising a power supply device and a plurality of battery systems connected in parallel, the power supply device electrically configured to control the charging or discharging of each of the plurality of battery systems connected to each of the plurality of battery systems; detecting an actual voltage of each battery system; controlling the start of battery systems with a low actual voltage for charging or discharging; and controlling the start of battery systems with a high actual voltage after the actual voltage of each battery system is balanced. The battery systems are directly controlled by the power supply device when connected in parallel to the power supply system, such that unlimited capacity expansion may be realized without redesigning the battery systems or adding a BMS.

### CROSS-REFERENCE TO RELATED APPLICATIONS

This non-provisional application claims priority under 35 U.S.C. § 119(a) on Patent Application No. 202111328611.5 filed in P.R. China on Nov. 10, 2021, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### BACKGROUND OF THE INVENTION

### 1. Field of the Invention

The application relates to the field of power supply control technology, and particularly to a battery management method and a power supply system.

### 2. Related Art

Currently, when a battery system in the existing power supply system cannot satisfy the requirement for a growing battery capacity, the number of battery systems in the power supply system shall be increased, or a larger capacity battery system shall be exchanged for capacity expansion. However, when high voltage battery systems are directly connected in parallel in the power supply system, a surge current is produced to the lower voltage system, and may cause failure of batteries. In addition, if the battery systems are directly connected in parallel, a total charging current limit of all batteries cannot be controlled, and the problem of exceeding a charging current limit of the single battery system may occur.

A power supply system uses battery systems with a precharging function, and the battery systems may be directly connected in parallel in the power supply system, and connected to a power supply device via communication lines for use. Alternatively, additional battery systems with the same specification are connected in parallel on the basis of the existing battery system and a centralized BMS system shall be additionally added to unified manage the battery systems connected in parallel.

### SUMMARY OF THE INVENTION

One aspect of the disclosure is to provide a battery management method integrated into a power supply system. In the method, a plurality of battery systems connected in parallel is directly controlled by a power supply device in the power supply system, such that unlimited capacity expansion of the battery systems may be realized without redesigning the battery systems or adding a BMS, and with no limit of a difference in voltages.

According to another aspect of the disclosure, it further provides a power supply system in which a power supply device directly controls a plurality of battery systems connected in parallel, such that unlimited capacity expansion of the battery systems may be realized without redesigning the battery systems or adding a BMS, and with no limit of a difference in voltages.

According to one aspect of the disclosure, it provides a battery management method integrated into a power supply system for smart start and controlling charge balance comprising:

providing the power supply system, wherein the power supply system comprises a power supply device and a plurality of battery systems connected in parallel, the power supply device electrically connected to each of the plurality of battery systems, and configured to control charging or discharging of each of the plurality of battery systems:

detecting an actual voltage of each of the plurality of battery systems;

controlling the start of battery systems with a low actual voltage for charging or discharging; and

controlling the start of battery systems with a high actual voltage after the actual voltage of each of the plurality of battery systems is balanced.

According to another aspect of the disclosure, it further provides a power supply system, comprising a power supply device and a plurality of battery systems connected in parallel, wherein the power supply device electrically connected to each of the battery systems, and configured to control charging or discharging of each of the battery systems, and wherein the power supply device comprises a battery control unit, wherein the battery control unit is configured to:

detect an actual voltage of each of the battery systems;

control the start of battery systems with a low actual voltage for charging or discharging; and

control the start of the battery systems with a high actual voltage after the actual voltage of each of the plurality of battery systems is balanced.

The above embodiments may provide a battery management method integrated into a power supply system, wherein a plurality of battery systems connected in parallel is directly controlled by the power supply device in the power supply system. In the case of with the requirement for capacity expansion, it is only necessary to connect the newly added battery system in parallel to the power supply system through communication lines and power lines, and in operation, the battery systems may be directly connected in parallel. The power supply device automatically recognizes the battery systems, and directly manages the whole battery parallel system without redesigning the battery systems or adding a central battery management system (BMS). Meanwhile, the power supply device firstly controls to start battery systems with a low voltage for charging or discharging, and then battery systems with a high voltage are started after the actual voltage of each of the plurality of battery systems is balanced while with no limit of the difference in voltages.

Meanwhile, further add the process of recognizing charging current limits of the started battery systems, and adjusting the charging current limits according to the actual current of each of the started battery systems to keep stable operation of the parallel battery system, and solve the problem that the battery systems directly connected in parallel cannot control the charging current limits while exceeding the charging current limit of the single battery system.

### BRIEF DESCRIPTION OF THE DRAWINGS

The above and other objects, features and advantages of the disclosure become more apparent with reference to detailed descriptions of the accompanying drawings, wherein,

FIG. 1 is a system block diagram of a power supply system.

FIG. 2 is a flow diagram of a battery management method according to one embodiment of the disclosure.

FIG. 3 is a detailed flow diagram of a battery management method in embodiment one of the embodiments of the disclosure.

FIG. 4 is a detailed flow diagram of a battery management method in another embodiment of the embodiments of the disclosure.

### DETAILED EMBODIMENTS OF THE INVENTION

To make objects, technical solutions and advantages of the invention clearer, hereinafter the invention is further explained in details with reference to the accompanying drawings and embodiments. It shall be understood that the detailed embodiments described here are only to explain the invention, not limiting the invention.

It shall be noted that when the specification specifies reference signs for elements in the drawings, although the same reference sign is shown in different drawings, the same reference sign represents the same element as could as possible. In addition, in the below description of the disclosure, when detailed descriptions of the known functions and constructions incorporated into the invention make the subject matter of the disclosure quite unclear, the detailed descriptions will be omitted.

Further, when the elements in the disclosure are described, terms such as “first”, “second”, “A”, “B”, “(a)”, “(b)” and the like may be used. These terms are only to distinguish one element from other elements, and essence, order, sequence, or number of the corresponding element is not limited thereto. When one element is described to be “connected to”, “coupled to” or “linked to” another element, it shall be understood that one element can be directly connected or coupled to another element, and also can be “connected to”, “coupled to” or “linked to” another element via a third element, or the third element may be interposed between one element and another element.

Still further, with respect to citation of “one embodiment”, “embodiments”, “exemplary embodiment”, or the like, it refers to that the described embodiment may include specific features, structures or characteristics, not that each embodiment must include these specific features, structures or characteristics. In addition, such expression does not refer to the same embodiment. Further, when the specific features, structures or characteristics are described combining with the embodiments, no matter whether they are clearly described, it has indicated that combination of these features, structures or characteristics into other embodiments is within the scope of knowledge of those skilled in the art.

Even further, the specification and subsequent claims use certain phrases to name specific components or parts, and those ordinary in the art shall understood that manufacturers can use different nouns or terms to call the same component or part. The specification and subsequent claims do not distinguish the components or parts with difference of names, but difference in functions as distinguishing criterion. In the whole specification and subsequent claims, “comprise” and “include” mentioned are open words, so they shall be explained to “include but not limited to”. Moreover, the word “connect” includes any direct or indirect electrical connection means. Indirect electrical connection means includes connection through other devices.

FIG. 1 is a principle block diagram of a power supply system according to one embodiment of the disclosure.

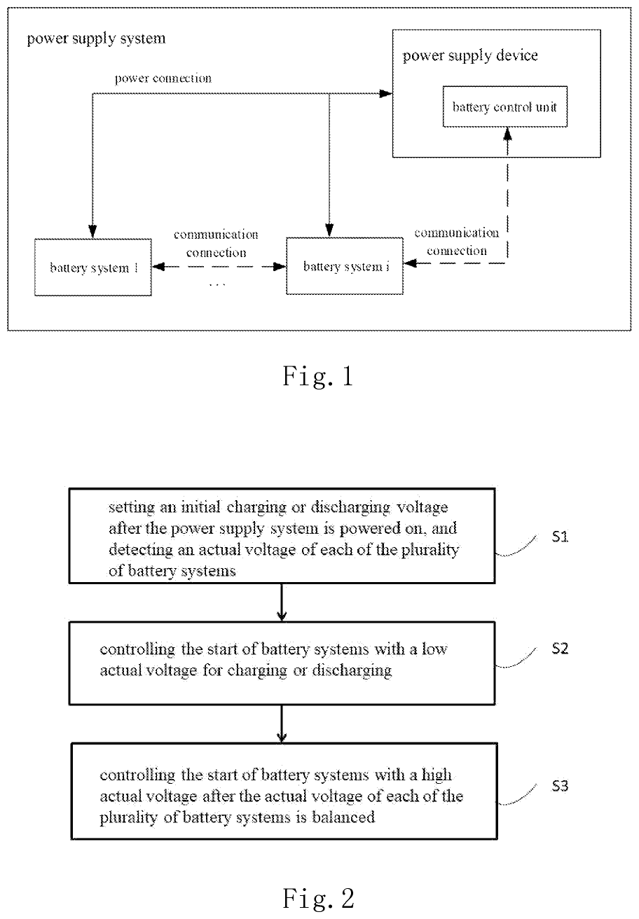

FIG. 2 is a basic flow diagram of a battery management method in embodiment one of the embodiments of the disclosure.

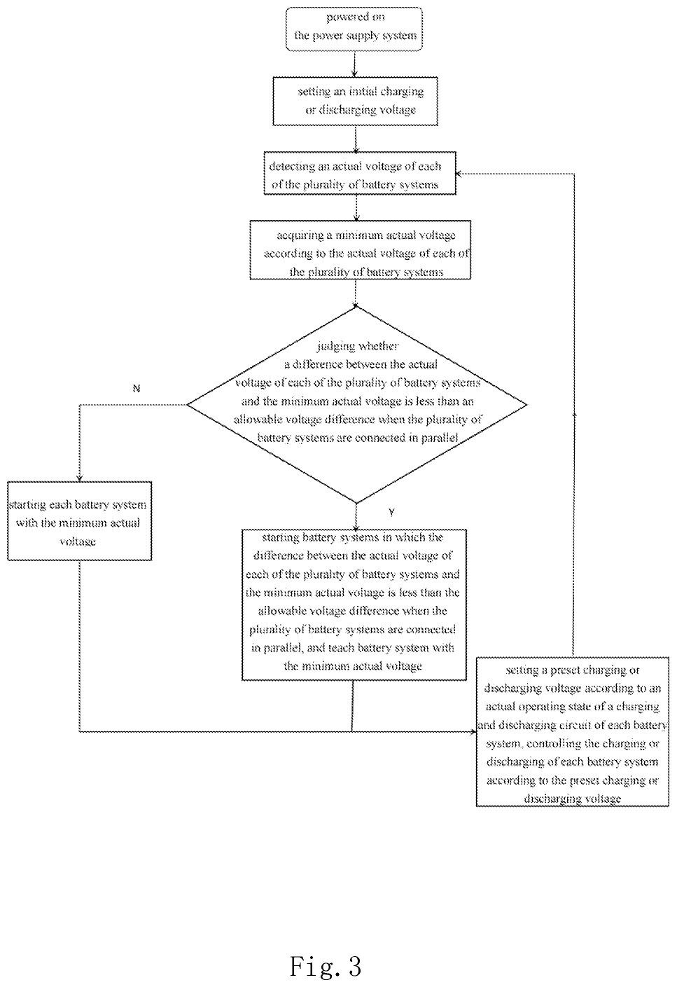

FIG. 3 is a detailed flow diagram of the battery management method in embodiment one of the embodiments of the disclosure.

As an example, as illustrated in FIG. 1, the power supply system in this embodiment comprises a power supply device and a plurality of battery systems connected in parallel. The battery systems can be battery systems including lithium ion batteries, sodium-ion batteries, potassium ion batteries or lead-acid batteries. The power supply device is electrically connected to each of the battery systems. The power supply device may be an uninterruptible power supply (UPS), but the application is not limited thereto. The power supply device comprises a battery control unit for controlling the charging or discharging of each battery system. To be specific,

as shown in FIGS. 2 and 3, a battery management method comprises the steps of:

setting an initial charging or discharging voltage after the power supply system is powered on, and detecting an actual voltage of each of the plurality of battery systems;

controlling the start of battery systems with a low actual voltage for charging or discharging; and controlling the start of battery systems with a high actual voltage after the actual voltage of each of the plurality of battery systems is balanced. To be specific,

in some embodiments,

controlling the start of battery systems with a low actual voltage comprises:

acquiring a minimum actual voltage according to the actual voltage of each of the plurality of battery systems;

judging whether a difference between the actual voltage of each of the plurality of battery systems and the minimum actual voltage is less than an allowable voltage difference when the plurality of battery systems are connected in parallel;

if yes, starting battery systems in which the difference between the actual voltage of each of the plurality of battery systems and the minimum actual voltage is less than the allowable voltage difference when the plurality of battery systems are connected in parallel and each battery system with the minimum actual voltage;

if not, starting each battery system with the minimum actual voltage.

After each battery system is started, setting a preset charging or discharging voltage according to an actual operating state of a charging and discharging circuit of each battery system, controlling the charging or discharging of each battery system according to the preset charging or discharging voltage, and detecting the actual voltage of each battery system.

In this embodiment, the plurality of battery systems are connected in parallel, and each battery system is directly controlled and managed by the power supply device. In the case of the capacity expansion, it is simply to connect the newly added battery system in parallel to the power supply system through communication lines and power lines, and in operation, the battery systems may be directly connected in parallel. The power supply device can automatically recognize the battery systems, and directly manage all battery systems connected in parallel without redesigning the battery systems or adding a central battery management system (BMS). Meanwhile, the power supply device firstly controls to start battery systems with a low voltage for charging or discharging, and battery systems with a high voltage are started after the voltage of each of the plurality of battery systems is balanced. The power supply system in the application has no voltage difference limitation during capacity of the battery system expansion because of the smart start and controlled charging balance.

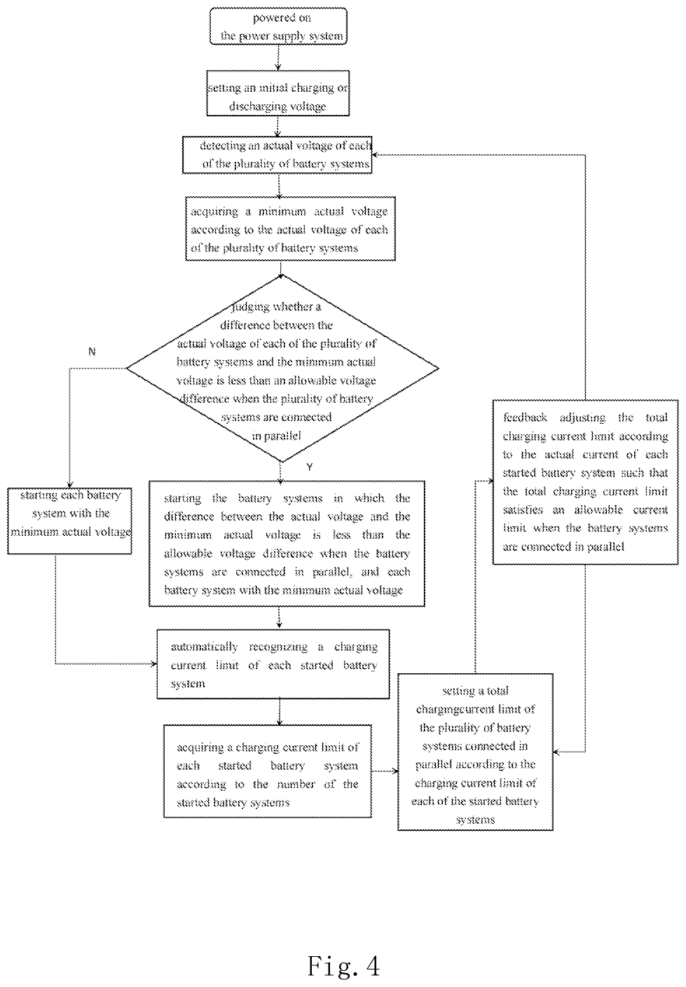

FIG. 4 is a flow diagram of a battery management method in another embodiment of the disclosure.

A battery management method comprises the steps of:

setting an initial charging or discharging voltage for each battery system after the power supply system is powered on, and detecting an actual voltage of each of the plurality of battery systems;

controlling the start of battery systems with a low actual voltage for charging or discharging. To be specific,

in some embodiments,

controlling the start of battery systems with a low actual voltage comprises:

acquiring a minimum actual voltage according to the actual voltage of each of the plurality of battery systems;

judging whether a difference between the actual voltage of each of the plurality of battery systems and the minimum actual voltage is less than an allowable voltage difference when the plurality of battery systems are connected in parallel;

if yes, starting battery systems in which the difference between the actual voltage each of the plurality of battery systems and the minimum actual voltage is less than the allowable voltage difference when the plurality of battery systems are connected in parallel, and each battery system with the minimum actual voltage;

if not, starting each battery system with the minimum actual voltage.

Automatically recognizing a charging current limit of each started battery system, and adjusting the charging current limit according to an actual current of each started battery system are specifically as follows:

in some embodiments, adjusting the charging current limit according to an actual current of each started battery system comprises:

acquiring a charging current limit of each started battery system according to the number of the started battery systems;

setting a total charging current limit of the plurality of battery systems connected in parallel according to the charging current limit of each of the started battery systems; and

feedback adjusting the total charging current limit according to the actual current of each started battery system such that the total charging current limit satisfies an allowable current limit when the battery systems are connected in parallel.

On the basis of the control method in the first embodiment, this embodiment further adds the process of automatically recognizing charging current limit of each started battery system, and adjusting the charging current limit according to an actual current of each started battery system, thereby keeping stable operation of the power supply system after capacity expansion.

To sum up, the battery management method integrated into the power supply system provided in the application, a plurality of battery systems connected in parallel is directly controlled by the power supply device in the power supply system. In the case of with the requirement for capacity expansion, the additional battery system are simply integrated into the power supply system in parallel through communication lines and power lines, and the battery systems may be directly connected in parallel in operation. The power supply device automatically recognizes the battery systems, and directly manages all battery systems connected in parallel without redesigning the battery systems or adding a central battery management system (BMS). Meanwhile, the power supply device firstly controls to start the battery systems with a low voltage for charging or discharging, and then the battery systems with a high voltage are started after voltage balance while with no limit of the difference in voltages. Meanwhile, further add the process of automatically recognizing charging current limit of each started battery system, and adjusting the charging current limit according to the actual current of each started battery system to keep stable operation of the whole power supply system, and solve the problem that the battery systems directly connected in parallel cannot control the charging current limits while exceeding the charging current limit of the single battery system.

The above descriptions and drawings only provide examples as the technical concept of the disclosure, and those ordinary in the art shall understand that without departing from essential features of the disclosure, various modifications and changes in form, such as, combination, separation, substitution and change of the construction, may be made to the embodiments described above. Therefore, the embodiments disclosed in the disclosure do not aim to limit but describing the technical concept of the disclosure, so the scope of the technical concept of the disclosure is not limited. The scope of the disclosure shall be explained based on the appended claims, and all technical concepts included in the equivalent scope of the appended claims shall be explained to be included into the scope of the disclosure.

Of course, the invention may further have various other embodiments, and those skilled in the art shall make various corresponding modifications and variations to the invention without departing from spirit and essence of the invention, but these corresponding modifications and variations shall belong to the scope protected by the appended claims of the invention.

What is claimed is:

1. A battery management method integrated into a power supply system for smart start and controlling charge balance, comprising:
providing the power supply system, wherein the power supply system comprises a power supply device and a plurality of battery systems connected in parallel, the power supply device electrically connected to each of the plurality of battery systems, and configured to control the charging or discharging of each of the plurality of battery systems;
detecting an actual voltage of each of the plurality of battery systems;
controlling the start of battery systems with a low actual voltage for charging or discharging; and
controlling the start of battery systems with a high actual voltage after the actual voltage of each of the plurality of battery systems is balanced.

2. The battery management method according to claim 1, wherein controlling the start of battery systems with a low actual voltage, comprising:
acquiring a minimum actual voltage according to the actual voltage of each of the plurality of battery systems;
judging whether a difference between the actual voltage of each battery system and the minimum actual voltage is less than an allowable voltage difference when the plurality of battery systems are connected in parallel;
if yes, starting battery systems in which the difference between the actual voltage of each battery system and the minimum actual voltage is less than the allowable voltage difference when the plurality of battery systems are connected in parallel, and each battery system with the minimum actual voltage;
if not, starting each battery system with the minimum actual voltage.

3. The battery management method according to claim 1, further comprising:
automatically recognizing a charging current limit of each started battery system; and
adjusting the charging current limit according to an actual current of each started battery system.

4. The battery management method according to claim 3, wherein adjusting the charging current limit according to an actual current of each started battery system, comprising:
acquiring a charging current limit of each started battery system according to the number of the started battery systems;
setting a total charging current limit of the plurality of battery systems connected in parallel according to the charging current limit of each of the started battery systems; and
feedback adjusting the total charging current limit according to the actual current of each of the started battery system such that the total charging current limit satisfies an allowable current limit when the battery systems are connected in parallel.

5. The battery management method according to claim 1, further comprising:
setting an initial charging or discharging voltage after the power supply system is powered on; and
setting a preset charging or discharging voltage according to a state of an actual charging and discharging circuit of each battery system after each battery system is started.

6. The battery management method according to claim 5, further comprising:
controlling the charging or discharging of each started battery system according to the preset charging or discharging voltage, and detecting the actual voltage of each of the battery systems.

7. A power supply system, comprising:
a power supply device and a plurality of battery systems connected in parallel, wherein the power supply device electrically connected to each of the plurality of battery systems, and configured to control charging or discharging of each of the plurality of battery systems, and wherein the power supply device comprises a battery control unit, wherein the battery control unit is configured to:
detect an actual voltage of each of the plurality of battery systems;
control the start of battery systems with a low actual voltage for charging or discharging; and
control the start of battery systems with a high actual voltage after the actual voltage of each of the plurality of battery systems is balanced.

8. The power supply system according to claim 7, wherein the battery control unit is further configured to:
acquire a minimum actual voltage according to the actual voltage of each of the plurality of battery systems;
judge whether a difference between the actual voltage of each battery system and the minimum actual voltage is less than an allowable voltage difference when the plurality of battery systems are connected in parallel;
if yes, start battery systems in which the difference between the actual voltage of each battery system and the minimum actual voltage is less than the allowable voltage difference when the plurality of battery systems are connected in parallel, and each battery system with the minimum actual voltage;
if not, start each battery system with the minimum actual voltage.

9. The power supply system according to claim 7, wherein the battery control unit is further configured to:
automatically recognize a charging current limit of each started battery system; and
adjust the charging current limit according to an actual current of each started battery system.

10. The power supply system according to claim 9, wherein the battery control unit is further configured to:
acquire a charging current limit of each started battery system according to the number of the started battery systems;
set a total charging current limit of the plurality of battery systems connected in parallel according to the charging current limit of each of the started battery systems; and
feedback adjust the total charging current limit according to the actual current of each started battery system such that the total charging current limit satisfies an allowable current limit when the battery systems are connected in parallel.

11. The power supply system according to claim 7, wherein the battery control unit is further configured to:
set an initial charging or discharging voltage after the power supply system is powered on; and
set a preset charging or discharging voltage according to a state of an actual charging and discharging circuit of each battery system after each battery system is started.

12. The power supply system according to claim 11, wherein the battery control unit is further configured to:
control charging or discharging of each started battery system according to the preset charging or discharging voltage, and detecting the actual voltage of each of the battery systems.
